(19) United States
(12) Patent Application Publication
(10) Pub. No.: US 2016/0162834 A1
(43) Pub. Date: Jun. 9, 2016

(54) Container Tracking Systems For Supply Chains And Related Methods

(71) Applicant: Barbara P. Masin, Santa Barbara, CA (US)

(72) Inventor: Barbara P. Masin, Santa Barbara, CA (US)

(21) Appl. No.: 14/937,187

(22) Filed: Nov. 10, 2015

Related U.S. Application Data
(60) Provisional application No. 62/087,539, filed on Dec. 4, 2014.

(51) Int. Cl. G06Q 10/08; G06K 7/10

(52) U.S. Cl. CPC G06Q 10/0833; G06K 7/10366

(57) ABSTRACT

The container tracking system embodiments described herein include tracking components at each stage of the supply chain, including filling plants (FPs), regional storage facilities such as Regional Cages (RCs), point of sale (POS) locations, and direct delivery service (DS) providers. The tracking components at each stage include Integrated Data Terminals (IDTs) and Handheld Readers (HRs) that read data from containers and identification (ID) cards and communicate this data to one or more container tracking server systems to update a container tracking database. These communications can also be real time communications. The container tracking system in part tracks data stored in RFID (radio frequency identification) tags that are affixed to the containers. The tagged containers can hold any desired material, such as such chemicals, gases, LPG (liquefied petroleum gas), beverages, liquids, and/or other desired materials.

### RELATED APPLICATIONS

This application claims priority to the following co-pending provisional application: U.S. Provisional Patent Application Ser. No. 62/087,539, filed Dec. 4, 2014, and entitled “CONTAINER TRACKING SYSTEMS FOR SUPPLY CHAINS AND RELATED METHODS,” which is hereby incorporated by reference in its entirety.

### TECHNICAL FIELD

The disclosed embodiments relate to asset tracking for containers and, more particularly, to systems that track containers within a supply chain.

### BACKGROUND

Most container supply operators such as chemical supply companies, LPG (liquefied petroleum gas) suppliers, small breweries, and/or other container suppliers (“the Operators”) today are tracking their containers manually, if they are tracking them at all. Companies are seeking to improve overall efficiency throughout their supply chains, and implement a comprehensive container tracking solution that will allow them to improve their return on investment and profitability.

In addition, existing solutions being offered to the market rely upon expensive portable data terminals that may cost hundreds or even thousands of dollars. If lost, damaged, or stolen, these represent a significant loss to the Operator. They also require careful operators, with a fairly high educational level who will handle the equipment gently and enter data on complex alpha-numeric keypads with attention to detail. They often rely on cabled solutions in the filling plants, which are complex to install, with fixed mounted readers that minimize flexibility and dictate process flow to certain fixed points in the filling plant. They feature expensive server hardware that must be maintained and can break, and quickly becomes outdated, and expensive software that requires operators to purchase licenses and periodic updates. As a result, adoption of these existing solutions by Operators has been slow.

Furthermore, many of the existing electronic tracking and identification solutions focus on in-plant automation. However, in many filling plants in-plant processes are largely manual, so return on investment (ROI) through capturing of in-plant operational data is minimal. Further, in-plant automation requires virtually 100 percent of all containers passing through the plant operations to be tagged.

### SUMMARY

The embodiments described herein for radio frequency identification (RFID) container tracking systems and related methods that track containers tagged with RFID tags through supply chains help to eliminate the above drawbacks and provide one or more of the following operational features and advantages:
(1) The RFID tracking system and related method embodiments do not require highly trained or highly skilled operators (no literacy requirement, no typing skills or other special competencies).
(2) The RFID tracking system and related method embodiments are designed to reduce human/machine interface. By reducing the human factor and automating processes, the disclosed embodiments ensure maximal data accuracy.
(3) Users are not required to key in data. Rather, they scan tags on containers when checking them in and out of respective facilities. The system does the rest of the data acquisition, storage, and tracking.
(4) Equipment is designed to be rugged. There are no keypads or monitors to break, although keypads and/or monitors could be at locations added within the disclosed embodiments, if desired.
(5) There are no communications cables to lose or damage. All communications are preferably wireless communications, for example, Bluetooth communications, GPRS (General Packet Radio Service) or other mobile device related communications, or other wireless data transmission methods.
(6) Equipment is configured to be inexpensive and easily replaceable.
(7) Equipment is configured to be energy independent. Further, system components will keep operating even during regional power outages because all equipment is battery operated. Thus, as long as Handheld Readers (HRs) and Integrated Data Terminals (IDTs) are recharged periodically, data collection can continue irrespective of power outages.
(8) In case of equipment malfunction, trouble tickets are automatically generated and pushed to the tracking system administrators, who can implement trouble shooting in real time.
(9) Data may optionally reside in the Cloud (e.g., Internet-based network server systems) in a secure off-site facility to protect against data loss. All data is also mirrored and backed up automatically.
(10) All data communications may optionally be encrypted. All stored data may also optionally be encrypted to ensure complete confidentiality of each Operator's data.
(11) Software updates are pushed to Operators and equipment/systems/components within the tracking system.
(12) There is no requirement for each Operator's IT (information technology) staff to maintain system hardware and software, or manage updates of user terminals at far-flung locations.
(13) System can also make use of existing national ID (identification) cards, thereby doing away with the need for Operators to issue special cards to all customers, and the expense and logistical complexities of replacing lost cards.
(14) All transponders and staff ID cards are ATEX (Potentially Explosive Atmosphere) certified.
(15) Additional reports or functionalities can also be prepared and added at the Operators request without requiring site visits by service provider personnel.
(16) Optionally, data can be accessed by authorized users through network interfaces from any location having internet access, thereby doing away with the need for dedicated access terminals. These data access interfaces also mean that data may optionally be accessed from desktop PCs (personal computers) in offices, laptop computers, smart phones, tablets and/or other network connected devices.
(17) Use of the RFID tracking system and related method embodiments can advantageously begin as soon as tagged containers move into the supply chain.
(18) Other features or advantages as described herein, and additional features and variations can also be provided while still taking advantage of the tracking system embodiments and related components described herein.

The main ROI (return on investment) is achieved through supply chain management. If the focus is on supply-chain management, ROI can begin virtually from the start of tagging.

It is further noted that the components of the embodiments described herein can be implemented in whole or in part. For example, in lieu of hosting the Operator's data being stored within the cloud such as within an Internet-based server system environment, an on-site server may be kept on premises that stores the Operator's data instead of or in addition to this data being stored in the cloud. Also, delivery may be made directly from the filling plant to the customer, in lieu of through further supply chain elements, as described below. The disclosed embodiments may also be used only in selected parts of the supply chain: for capturing containers being loaded or unloaded at the filling plant(s), or the distribution center(s), or the storage facility(facilities), or the retail point(s) of sale, or containers being issued to and returned by end customers, or any combination thereof. In addition, the Integrated Data Terminals may be adopted and used; however, in lieu of a pair of 1-button readers, a pair of readers or a single reader with a limited number of buttons, or touch screen, may also be utilized. Other variations can also be implemented while still taking advantage of the tracking system embodiments and related components described herein.

For one embodiment, a method to track containers within a supply chain from filling plants to customers is disclosed. The method includes providing integrated data terminals (IDTs) and handheld readers (HRs) to supply chain locations including one or more filling plants (FPs), one or more regional cages (RCs), one or more point of sale (POS) locations, and one or more delivery service (DS) provider locations. The method also includes, at each supply location, reading data from RFID (radio frequency identification) tags affixed to incoming and outgoing containers using one or more handheld readers, wirelessly transferring the data from the one or more handheld readers to an integrated data terminal, wirelessly communicating the data from the integrated data terminal to one or more server systems, and using the data to update container data stored within a database associated with the one or more server systems.

In additional embodiments, the containers, when filled at one or more filling plants, hold at least one of chemicals, gases, LPG (liquefied petroleum gas), beverages, or liquids. In further embodiments, each filling plant, each regional cage, and each delivery service provider location is provided a first handheld reader configured to read incoming containers and a second handheld reader configured to read outgoing containers. In still further embodiments, each point of sale location is provided a handheld reader configured to read both incoming containers and outgoing containers.

In additional embodiments, the method also includes, at each supply chain location, reading identification numbers from identification (ID) cards associated with the incoming and outgoing containers and communicating the identification numbers to the one or more server systems. In further embodiments, the ID cards comprise at least one of ID cards associated with delivery drivers or ID cards associated with customers.

In additional embodiments, the method also includes, at each filling plant, providing a list of containers due for maintenance and alerting an operator if data read from a container indicates that the container is on the list. In further embodiments, the method also includes, at each filling plant and each regional cage, storing the data within the one or more handheld readers and subsequently downloading of the data to the integrated data terminal. In still further embodiments, the method also includes, at each point of sale location, communicating the data from the one or more handheld readers to the integrated data terminal in real time. In further embodiments, the method also includes tracking containers as they move through the supply chain locations and identifying missing containers using the container data stored within the database.

For one embodiment, a system to track containers within a supply chain from filling plants to customers is disclosed including a plurality of integrated data terminals (IDTs) with at least one integrated data terminal being located at a plurality of supply chain locations including one or more filling plants (FPs), one or more regional cages (RCs), one or more point of sale (POS) locations, and one or more delivery service (DS) provider locations. The system also includes a plurality of handheld readers (HRs) distributed among the plurality of supply chain locations, a database configured to store container data, and one or more server systems coupled to the database. For the system, each handheld reader is configured to read data from RFID (radio frequency identification) tags affixed to containers and to wirelessly transfer the data to an integrated data terminal; each integrated data terminal is configured to wirelessly communicate the data from a handheld reader to one or more server systems; and the one or more server systems are configured to use the data to update container data within the database.

In additional embodiment, the containers are configured to hold at least one of chemicals, gases, LPG (liquefied petroleum gas), beverages, or liquids. In further embodiments, the plurality of handheld readers comprise a pair of handheld readers for each filling plant, each regional cage, and each delivery service provider location where each pair of handheld readers including a first handheld reader configured to read incoming containers and a second handheld reader configured to read outgoing containers. In still further embodiments, the plurality of handheld readers include a single handheld reader for each point of sale location where each single handheld reader being configured to read both incoming containers and outgoing containers.

In additional embodiments, an integrated data terminal or a handheld reader at each supply chain location is configured to read identification numbers from identification (ID) cards associated with the incoming and outgoing containers. In further embodiments, the ID cards comprise at least one of ID cards associated with delivery drivers or ID cards associated with customers.

In additional embodiments, at least one handheld reader at each filling plant is configured to store a list of containers due for maintenance and to alert an operator if data read from a container indicates that the container is on the list. In further embodiments, the handheld readers at the filling plants and regional cages are configured to store the data read from containers for subsequent download to the integrated data terminals. In still further embodiments, handheld readers at each point of sale location are configured to communicate the data in real time read from containers to the integrated data terminals. In further embodiments, the one or more server systems are configured, using the container data stored within the database, to allow containers to be tracked as they move through the supply chain locations and to allow missing containers to be identified.

Different or additional features, variations, and embodiments can be implemented, if desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is an example embodiment for a container tracking system including filling plants (FPs), Regional Cages (RCs), point of sale (POSs) locations, delivery service (DSs) providers, customers, tagged containers (Cs), Integrated Data Terminals (IDTs), Handheld readers (HRs), and container tracking server system(s) including a database for system data.

FIG. 2A is a block diagram of an example embodiment to process containers at filling plants (FPs).

FIG. 2B is a process flow diagram of an example embodiment to process of incoming containers at filling plants (FPs).

FIG. 2C is a process flow diagram of an example embodiment to process of outgoing containers at filling plants (FPs).

FIG. 3 is block diagram of an example embodiment to process containers at Regional Cages (RCs).

FIG. 4A is a block diagram an example embodiment to process containers at Point of Sale (POS) locations.

FIG. 4B is a process flow diagram of an example embodiment to process incoming and outgoing containers at a POS location.

FIG. 5A is a block diagram of an example embodiment to process containers at delivery service (DS) provider locations.

FIG. 5B is a process flow diagram of an example embodiment to process incoming and outgoing containers at a customer location.

### DETAILED DESCRIPTION

The container tracking system embodiments described herein includes components at each stage of the supply chain, including filling plants (FPs), regional storage facilities such as Regional Cages (RCs), point of sale (POS) locations, and direct delivery service (DS) providers. Other and/or different locations could also include system infrastructure. The container tracking system in part tracks data stored in RFID (radio frequency identification) tags that are affixed to the containers. The tagged containers can hold any desired material, such as such chemicals, gases, LPG (liquefied petroleum gas), beverages, liquids, and/or other desired materials.

Example system objectives, components, features, and process flows are now described in more detail. It is further noted that different and/or additional features can also be implemented, as desired, and related systems and methods can be utilized as well.

### Overall Objectives of Operator Container Tracking System

Operators wish to improve overall efficiency throughout the supply chain, and implement a comprehensive container tracking solution that will allow them to perform one or more of the following objectives:
(1) Know the exact stock levels at each filling plant (FP) and each Regional Cage (RC) and retail Point of Sale (POS), as well as container status, in real time.
(2) Produce concrete and specific data for use by the Operator's accounting department.
(3) Identify all containers that are due for requalification and set them aside to ensure that they are properly processed.
(4) Optimize the use of the Operator's assets.
(5) Protect containers and contents (e.g., LPG) from theft and loss.
(6) Identify which customers are returning damaged containers.
(7) Identify containers that have been removed from circulation.
(8) Automate customer ordering.
(9) Automate payment processing.
(10) Other features and advantages available through the disclosed tracking system.

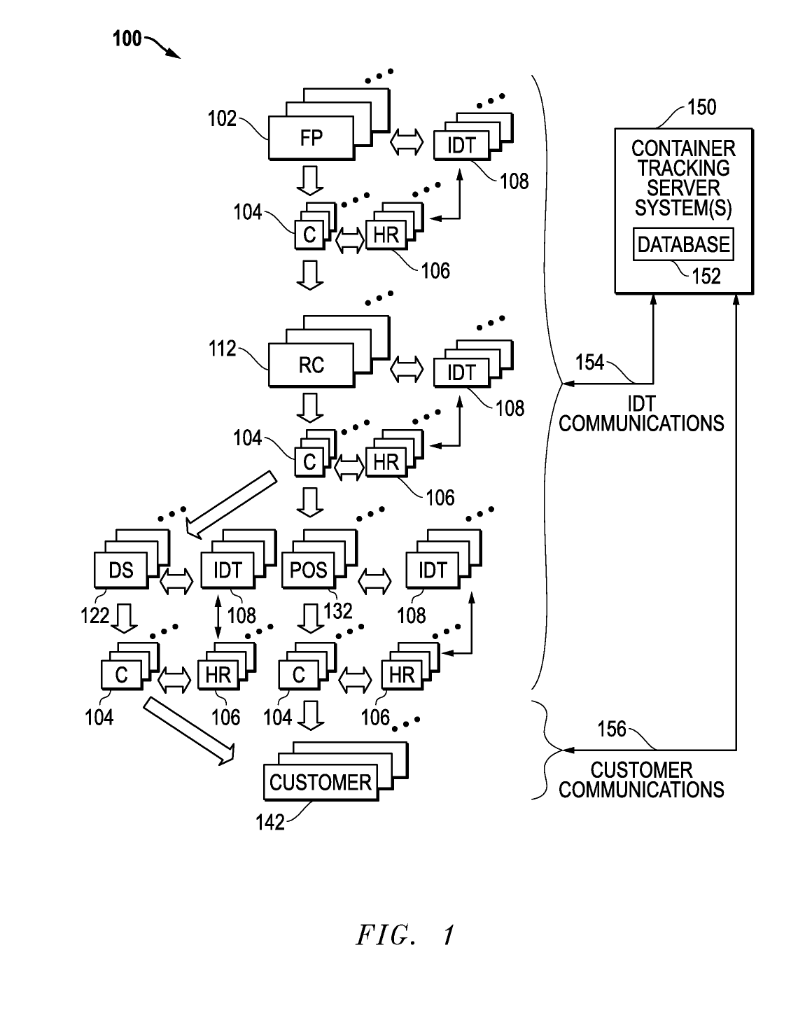

FIG. 1 provides an example embodiment 100 for a container tracking system. As described herein, one or more tagged containers (Cs) 104 are provided from one or more filling plants (FPs) 102 to one or more Regional Cages (RCs) 112. One or more tagged containers (Cs) 104 are provided from the Regional Cages (RCs) 112 to one or more point of sale (POS) locations 132 and/or to one or more direct delivery service (DS) providers 122. One or more tagged containers (Cs) 104 are provided from the one or more point of sale (POS) locations 132 and/or from one or more direct delivery service (DS) providers 122 to one or more end user customers 142 (e.g., retail, commercial, etc.). At each location, one or more handheld readers (HRs) 106 are used to read the RFID tags for the tagged containers 104 and to communicate data with one or more Integrated Data Terminals (IDTs) 108. The IDTs 108 communicate with the one or more container tracking server systems 150 to store and retrieve container data with respect to the database 152, and customers 142 and/or other system components can also communicate with the container tracking server systems 150. These container tracking server systems 150, for example, can be in the Cloud (e.g., Internet-based server system). Communications can preferably be wireless communications to facilitate ease of communications and to avoid cables. It is again noted that different and/or additional features can also be implemented, as desired, and related systems and methods can be utilized as well.

### Supply Chain Tracking—from Filling Plant (FP) to Point of Sale (POS)

### Objectives

Operators wish to improve supply chain tracking for tagged containers 104 from each filling plants (FP) 102 to the ultimate point of sale (POS) to the customer 142. In part, one or more of the following objectives are desired:
(1) Count and identify tagged containers 104 being dropped off and turned in at the filling plants (FPs) 102, at participating Regional Cages (RCs) 112, distributors 122, and at participating Point of Sale (POS) retail locations 132.
(2) Count and identify containers 104 assigned to individual truck drivers conveying containers 104 between filling plant (FP) 102, Regional Cages (RCs) 112 and retail locations 132.
(3) Associate above data with the location identity.
(4) Capture time and date for each scan.
(5) Determine if each truck driver is promptly returning containers 104, or if containers 104 are going missing at any point of the supply chain.
(6) Determine which tagged containers 104 are at which Regional Cage (RC) 112, distributor 122, retail location 132 or filling plant 102. It is also noted that references herein to a distributor also refers to sub-distributors or dealers or other points of distribution in the supply chain that are not retail or point of sale contacts with end customers 142. Further it is noted that “Regional Cage” as used herein refers to any type of storage location where containers 104 are stored within the supply chain.
(7) Determine how long tagged containers 104 remain at each location.
(8) Determine cycle time of tagged containers 104.
(9) Provide on-going customer consumption information, allowing development of targeted loyalty and promotion programs by Operator marketing departments.
(10) Other features and advantages available through the disclosed tracking system.

### Filling Plants (FPs)—Example Process Flow and Components

The supply chain tracking system follows tagged containers 104, such as LPG containers, from the filling plants (FPs) 102 to Regional Cages (RCs) 112, all the way to retail points of sale (POSs) 132 and back, providing each Operator with data on its supply chain, cycle times and inventory levels. The container tracking system 100 is configured to track containers 104 from one or more filling plants 102 within the supply chain (e.g., nine filling plants) to one or more Regional Cages 112 within the supply chain (e.g., eight Regional Cages) to one or more retail outlets 132 for the tagged containers 104. Further, for the embodiments described herein that use existing identification (ID) cards, Operator customers can be tracked without the Operator incurring additional expense for issuing ID cards.

Each driver is issued a uniquely coded RFID Card, which serves to identify him to the system.

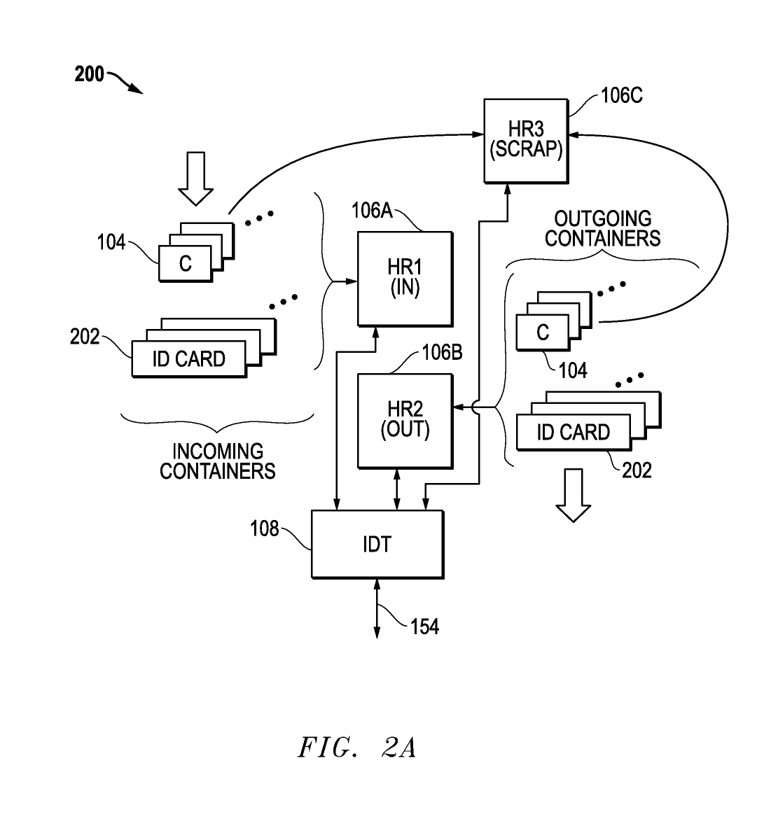

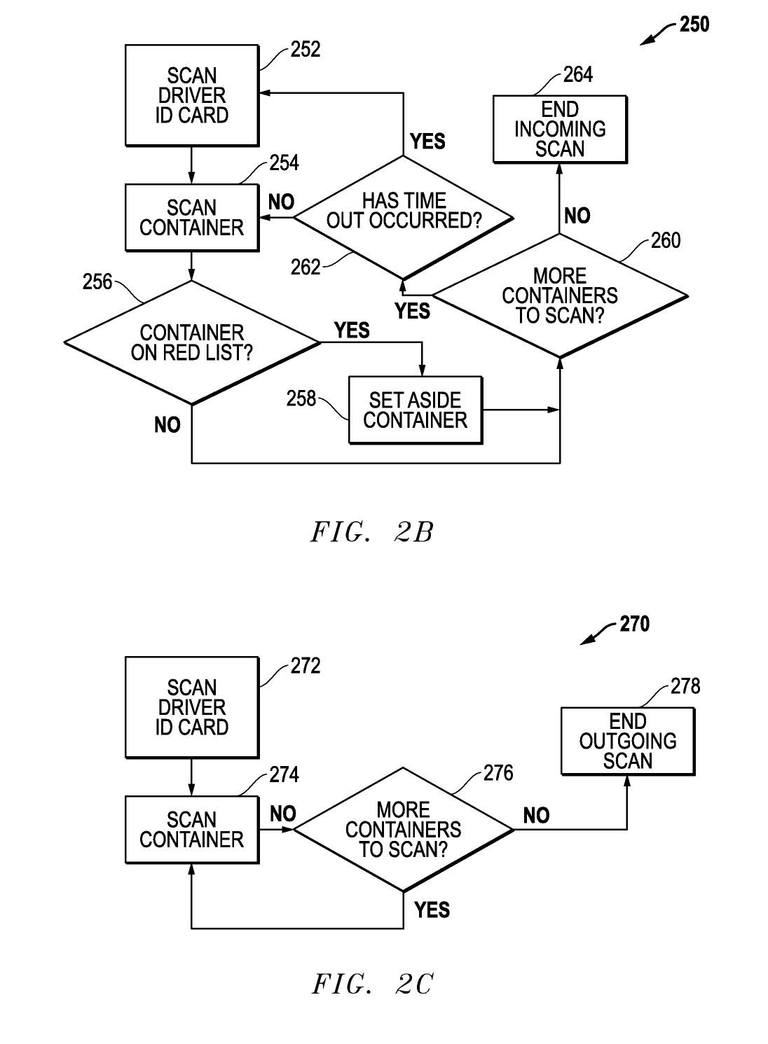

FIG. 2A is a block diagram of an example embodiment 200 to process containers 104 at filling plants (FPs) 102. Each team involved in loading and unloading trucks is equipped with a pair of Handheld Readers (HRs) 106A/106B that read data from the RFID tags for the tagged containers 104, ID cards 202, and/or other desired information. Each of the two Handheld Readers 106A/106B can be configured with recognizable identifying markings, coloring or design. For example, the FIRST Handheld Reader (HR1) 106A can be used to read and identify containers 104 turned in, and the SECOND Handheld Reader (HR2) 106B can be used to read and identify containers 104 shipped out. This pair of Handheld Readers (HR1/HR2) 106A/106B are used by the workers to manually scan containers 104 being unloaded and loaded, as well as driver ID cards 202. Each facility can also have a dedicated reader 106C to record scrapped containers, and an Integrated Data Terminal (IDT) 108 to which the data gathered in the handheld readers is uploaded. The Integrated Data Terminal 108 communicates automatically with the Operator database 152 associated with the container tracking server system 150, which can reside in the Cloud (e.g., Internet-based server system) as described above. Further as described above, the Operator database 152 can also be stored other locations instead of or in addition to the Cloud, such as in an on-site server system. It is also noted, as described herein, that a single reader 106A could be used for both IN and OUT scans, and the IN or OUT scan operations on the reader 106A can be selectable by the worker. Disambiguation in case of missed scans can be handled using upstream or downstream IN/OUT scans done at other supply chain locations.

FIG. 2B is a process flow diagram of an example embodiment 250 to processing of incoming containers 104 at filling plants (FP) 102. In block 252, when the truck driver arrives, the Driver presents his Driver ID Card 202 to be scanned using the FIRST Handheld Reader HR1 (IN position) 106A, and dock workers begin off-loading containers 104 from the truck, scanning the containers 104 brought off the trucks with the first reader HR1 106A in block 254. Their ID numbers are automatically captured, associated with the truck driver's ID, and saved with a time and date stamp. The reader contains a RED LIST of all containers 104 that are due or overdue for requalification/scheduled maintenance. A determination is therefore made whether or not a scanned container is on the RED LIST in block 256. When such a container 104 is scanned, the reader beeps and the LCD flashes, alerting the operator to set aside the container 104 in bock 258. Flow passes to block 260, where a determination is made if there are more containers to scan. If “NO,” then the incoming scan ends in block 264. If “YES,” a determination is made if a time out has occurred in block 262. For example, if more than 30 seconds go by without a scan, the reader times out, and the Driver must rescan his Driver ID Card 202 in block 252 before the first reader HR1 will accept more container scans in block 254.

FIG. 2C is a process flow diagram of an example embodiment 270 to process of outgoing containers 104 at filling plants (FPs) 102. After all containers 104 have been unloaded, the driver scans his Driver ID Card 202 in block 272 using the SECOND Handheld Reader HR2 (OUT position) 106B, to initiate the loading process. Each container 104 carried onto the truck is manually read using the Handheld Reader HR2 in block 274. Flow passes to block 276, where a determination is made if there are more containers to scan. If “NO,” then the outgoing scan ends in block 278. If “YES,” then flow passes back to block 274.

Periodically, users bring the readers 106 to the filling plant office. The administrative assistant holds the reader near the Integrated Data Terminal 108 and presses the trigger button several times in rapid succession to initiate synchronization. The reader 106 pushes all its saved readings to the Integrated Data Terminal 108, and the Integrated Data Terminal 108 updates the reader's RED LIST and list of authorized Driver ID cards. This synchronization process takes place via Bluetooth or other wireless data transmission method; no communications cable is required. The Integrated Data Terminal 108 in turn receives updated lists of staff cards and containers 104 that have been processed through requalification so that its RED LIST is always current.

Upon completion of this process, the system knows exactly which tagged containers 104 have been loaded onto each truck, the time and date of loading, and the identity of the driver into whose charge they have been placed. Once all containers 104 are tagged, the system has created a complete virtual bill of lading for the truck, listing all container IDs loaded on each truck leaving the plant.

Likewise, the system knows exactly which tagged containers 104 are on the truck when it returns to the plant, the date and time each tagged container is unloaded in the plant, and the identity of the driver.

The Handheld Reader (HR) 106 operates according to the requirements and functional operations described herein for the containing tracking operations and is configured to perform or meet one or more of the following features or functions:
(1) Simplify operation using only one button for reading and other operations.
(2) Minimize operator decision making.
(3) Reduce required keystrokes as human input creates likely errors/mistakes.
(4) Automate as many processes as possible.
(5) Include fail safe and redundancy features to improve reliability.
(6) Have a rugged design and reliable operation in the container (e.g., LPG container) environment.
(7) Include an internally rechargeable battery for simplified operation and prevent battery pilferage. For example, the battery can be a non-standard battery, and the batter can be included within the Handheld Reader such that it cannot be removed or easily removed by Operators.
(8) Handheld Reader unit is inexpensive, and easily replaced to reduce the impact of physical damage, loss or theft.
(9) Other features and advantages available through the disclosed tracking system.

The Integrated Data Terminal (IDT) 108, for example, at each filling plant (FP) location 102 can be implemented, for example, as a headless computer terminal with LED (light emitting diode) lights or an LCD (liquid crystal display) display or other visible features to indicate operational status (for example, visible ON/OFF/ERROR indicators) and communications status (for example, TRANSMITTING/RESTING/INVALID READ indicators). The IDT 108 is also designed to be rugged and efficient. For example, the IDT 108 can be implemented so that it does not require a keypad, mouse, and/or LCD monitor and/or does not require communication cables to operate so as to help reduce the risk that parts break or become lost. Further, the IDT 108 is designed to reduce human input to virtually zero so that there are no keystrokes and data entry is automated. The IDT 108 also communicates with external devices through Bluetooth communications and/or other wireless data transmission methods. The IDT 108 can also communicate with the central database 152 associated with the container tracking server systems 150 through GPRS communications and/or other wireless data transmission methods, thereby eliminating the need for communications cables. The IDT 108 is also battery powered, allowing autonomous operation for several hours in the event of power failures.

### Scrapped Containers—Example Process Flow and Components

Each filling plant operation (FP) has a dedicated reader 106C that records discarded containers to determine which containers have been properly removed from circulation and alert the Operator to the illicit reentry of discarded containers into the supply chain.

### Regional Cages (RCs) and Distribution Centers—Example Process Flow and Components

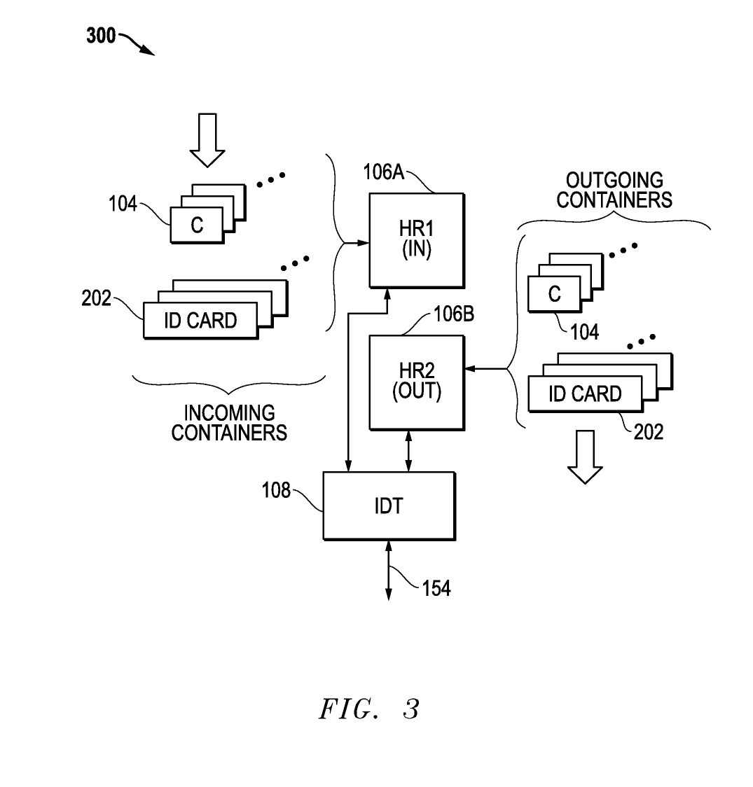

FIG. 3 is a block diagram of an example embodiment 300 to process containers 104 at Regional Cages (RCs) 112. Each Regional Cage location and distribution center 112 is issued an Integrated Data Terminal 108 and a pair of handheld readers 106A/B. The FIRST reader 106A is used for scanning INBOUND containers 104 and has recognizable markings, coloring or design. The SECOND reader 106B is used for scanning OUTBOUND containers 104 and has other recognizable markings, coloring or design. It is also noted, as described herein, that a single reader 106A could be used for both IN and OUT scans, and the IN or OUT scan operations on the reader 106A can be selectable by the worker. Disambiguation in case of missed scans can be handled using upstream or downstream IN/OUT scans done at other supply chain locations.

When workers unload and load containers at Regional Cages and distribution centers 112 they follow the same process described above of scanning containers with the IN reader 106A, and the OUT reader 106B. Periodically the readers 106A/B are brought to the Integrated Data Terminal 108 so that wireless data synchronization can take place. The Integrated Data Terminal 108 in turn syncs with the Operator's database 152 associated with the server systems 150, which again can reside in the Cloud as one or more cloud-based server systems.

At these Regional Cage locations 112, there is no RED LIST for containers due for requalification. That sort-out happens only at the filling plants 102. However, at each Regional Cage location 112 the readers 106 will be populated with a list of Driver ID numbers for drivers who are authorized to pick up and deliver containers 104 from that location 112.

Again, the components are configured so that no keypad data entry is required by Regional Cage staff.

### Retail Point of Sale (POS) Locations—Example Process Flow and Components

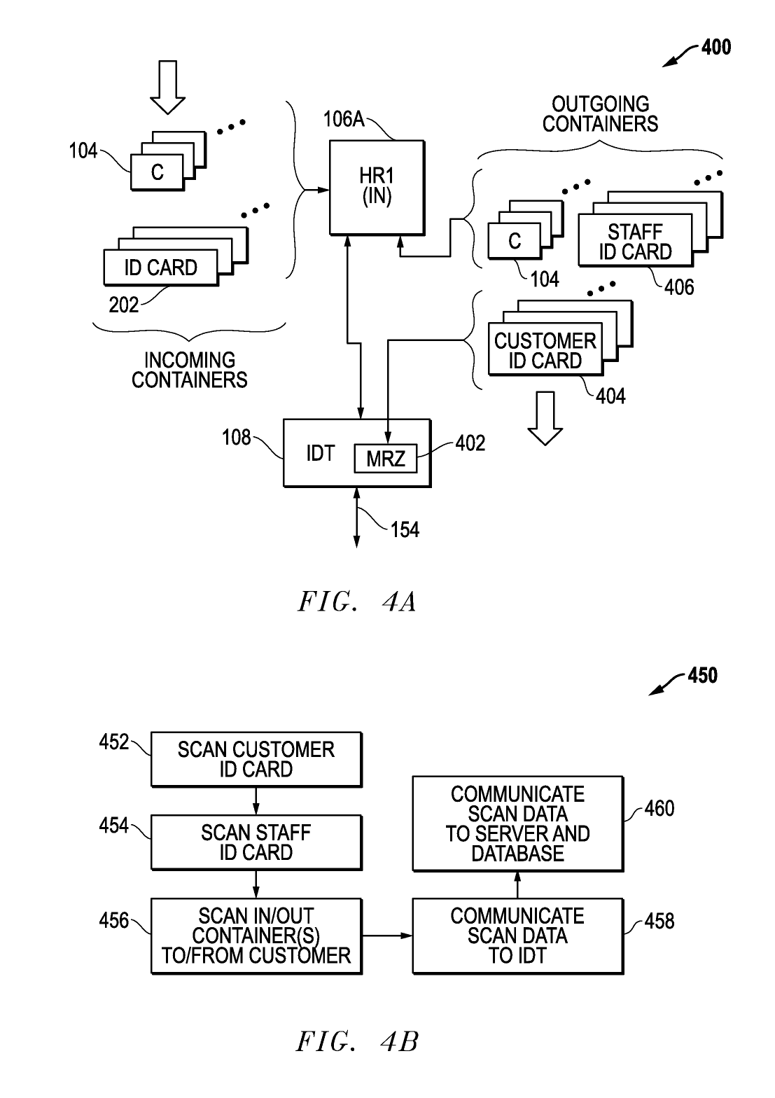

FIG. 4A is a block diagram an example embodiment 400 to process containers 104 at Point of Sale (POS) locations 132. Each Point of Sale (POS) location 132 is issued an Integrated Data Terminal 108 which has an MRZ (Machine Readable Zone) scanner 402, which is placed on the sales counter where customers 142 are attended to, and one Handheld Reader 106A which may move throughout the facility.

At all Point of Sale (POS) locations 132, when workers unload and load containers 104, they use one reader 106A for both IN and OUT scans. The IN or OUT scan operations on the reader 106A are selectable by the worker. Disambiguation in case of missed scans will be handled using upstream or downstream IN/OUT scans done at other supply chain locations such as Regional Cages 112 and at the filling plants 102. It is also noted, as described above, that two readers 106A/B could also be used separately for IN and OUT scans.

FIG. 4B is a process flow diagram of an example embodiment 450 to process at a POS location 132. During every in-store sales transaction, the sales clerk will first swipe the customer's National ID Card or other ID Card 404 on the MRZ scanner 402, in block 452, automatically capturing the name and national ID number of the individual. Then he reads his RFID Staff Card 406 with the Handheld reader in block 454, to identify himself to the system, before scanning containers 104 returned by and issued to the customer 142 at the sales counter with the Handheld reader 106, in block 456. The Handheld reader 106 communicates these scans to the Integrated Data Terminal 108 in real time, in block 458.

Transactions effected at the retail locations are communicated by the Integrated Data Terminals 108, in block 460, to the database 152 and related server system 154, for example, residing in the Cloud in real time.

Store owners/managers may be issued batches of RFID Staff Cards 406. They may update the container tracking system database 152 to add and delete authorized employees from their particular location by sending the ID number of the RFID Staff Card in question via SMS (short message service) text from their mobile phones and/or through other communication methods.

Again, the components are configured so that no keypad data entry is required by retail staff.

### Supply Chain Tracking—Consumer Platform

For home/direct deliveries from sales locations, embodiments for the container tracking system also include a consumer platform that allows customers to book containers and make payments through their mobile phones.

In jurisdictions that have an existing government-issued national ID card or other widely used form of personal identification (e.g., automobile license ID, etc.) having a mag stripe, barcode, MRZ code or similar readable feature, the container tracking system uses this form of pre-existing government-issued identification, or other widely used form of personal identification, to automatically identify (Auto ID) individual customers. One important factor for this Auto ID feature is that the personal identification include a unique numeric or alpha-numeric identifier for each ID holder, which may be automatically captured by a compatible electronic reader (e.g., mag stripe reader, barcode scanner, OCR (optical character recognition) scanner, MRZ scanner, or other suitable reader). This Auto ID approach has the advantage of leveraging off the existing ID card issuing infrastructure, and eliminates the expense and logistical complexity to the Operator of issuing and replacing lost ID cards. Within this description, it is noted that references to “MRZ” should be interpreted as referencing other forms of auto-readable ID, including but not limited to barcode and mag stripe, smart chips, or touch buttons. Further, references to “national ID card” should be interpreted as referencing any government issued national ID card or other, widely used form of personal identification; and references to “national ID number” should be interpreted as referencing the unique numeric or alpha-numeric identifier for each ID holder.

### Objectives

The customer platform can provide in part one or more of the following objectives are desired:
(1) Provide a platform for customers to book containers and pay for them electronically, via their mobile phones.
(2) Identify which customer has booked the container.
(3) Identify the customer's location.
(4) Identify the sales outlet that is best positioned to reach that customer's location.
(5) Confirm customer has pre-paid the proper amount.
(6) Confirm delivery of container at customer's location.
(7) Confirm that the customer has a deposit on file/container to give in exchange.
(8) Other features and advantages available through the disclosed tracking system.

### Booking Containers, Direct Delivery, and Payment—Example Process Flow and Components

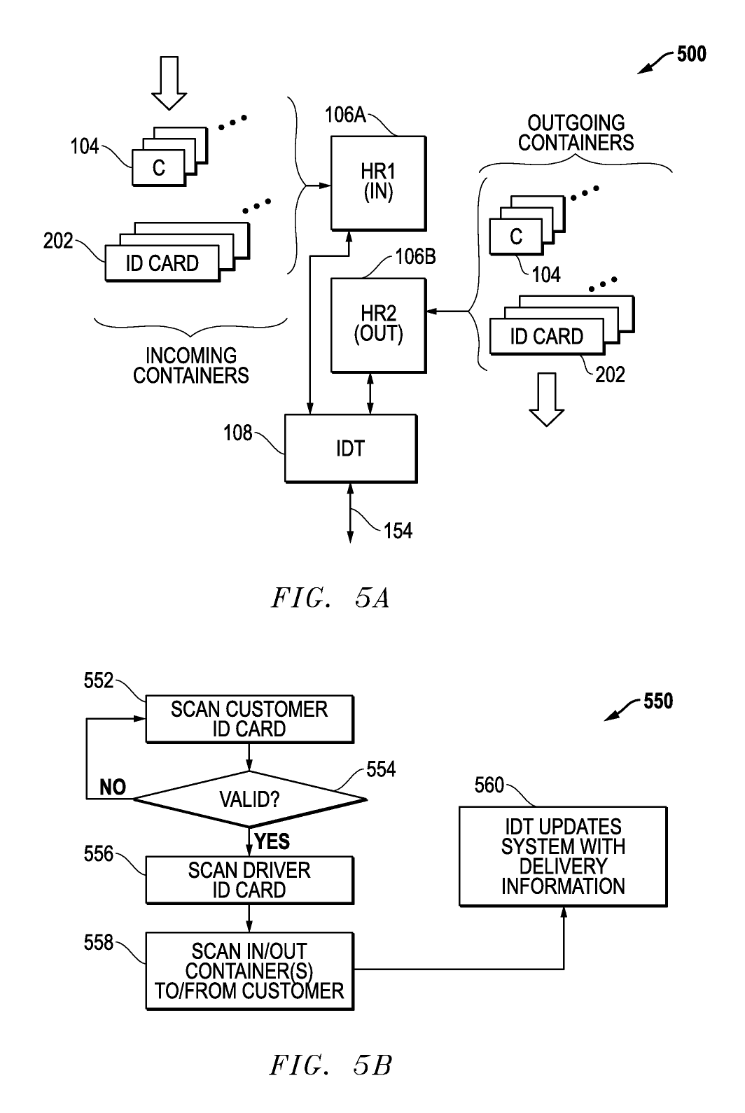

FIG. 5A is a block diagram of an example embodiment 500 to process containers 104 at delivery service (DS) provider locations 122. For direct customer deliveries, retail outlets that provide deliveries are no longer the last link in the chain, which becomes the customer delivery location. Consequently, each retail delivery outlet 122 is provided a second Handheld reader 106B, in addition to a first Handheld reader 106A, so that containers 104 passing IN and OUT of the facility 122 can be read differentially, as at the filling plants (FPs) 102 and Regional Cages (RCs) 112. It is also noted, as described herein, that a single reader 106A could be used for both IN and OUT scans, and the IN or OUT scan operations on the reader 106A can be selectable by the worker. Disambiguation in case of missed scans can be handled using upstream or downstream IN/OUT scans done at other supply chain locations.

If each of the retail outlets providing home and direct deliveries have two delivery drivers on staff, for example, each of them will be equipped with an Integrated Data Terminal with MRZ scanner or similar auto ID detector and a Handheld Reader, allowing them to record that deliveries are made to the proper recipient.

Identify which Customer has Booked the Container.

The customer sends an SMS text with his national ID number (for consumers) or customer account number (for commercial customers) and the number of containers to be delivered. The system verifies whether payment has been made. It will be necessary for containers being booked for delivery to be prepaid.

Identify the Customer's Location.

Customers desiring home delivery sign up with the retail delivery service by completing and mailing in a form, with their national ID number, name and address to the head office, where personnel would key in this data. Alternatively, registration may be done on-line via a form that is completed by the customer. On-line registrations may be entered directly into the system. Customers may provide several national ID numbers, for instance, the lady of the house, and the maid and the cook. For commercial accounts, the customer will be required to provide national ID numbers for all the personnel authorized to receive containers. If no authorized person is present when a delivery attempt is made, the driver is instructed not to leave the containers.

Identify the Sales Outlet that is Best Position to Reach that Customer's Location.

At the time the customer's address information is keyed in, the head office will select the sales outlet with best physical proximity to that address and associate it with the customer's ID.

Confirm Customer has Pre-Paid the Proper Amount.

When the customer's SMS text booking is received, the system will automatically confirm whether payment has been made via the mobile phone. The invention provides for optional integration with all of these subject to a suitable API (Application Programming Interface) being provided for each.

Confirm Delivery of Container at Customer Location.

Once the booking is received and pre-payment is confirmed, the system will push the request to the designated sales outlet 122. The sales outlet 122 will receive the customer ID number, address, and the number of containers required.

The Integrated Data Terminal 108 at each of the retail locations 122 that do deliveries connects to a Bluetooth or other wireless data transmission method-enabled printer. Turning on or resetting the printer prompts it to reinitiate contact with the Integrated Data Terminal 108, triggering a print-out of the orders booked for that location, along with the address for each location.

The driver loads up full containers 104 and goes on his deliveries with the print-out in hand telling him which accounts to visit, and an Integrated Data Terminal and Handheld Reader.

FIG. 5B is a process flow diagram of an example embodiment 550 to process incoming and outgoing containers at a customer location 142. Once he arrives at a customer location, the driver swipes the customer's national ID card on the Integrated Data Terminal, in block 552, to identify the customer to the system. The Data Terminal 108 will alert him if the customer's card is not valid, in block 554. If no valid MRZ code is scanned, the driver is instructed not to leave a container at this location. Once a valid customer ID has been presented, the driver identifies himself to the system by scanning his Driver ID on the handheld reader 106, in block 556. He then scans the empty container(s) being turned in. (Further, at Operator's option, the worker can also use his RFID placeholder ID if an untagged container is offered, although such placeholder IDs are not necessary for operation of the system.) Then he scans the full containers 104 being issued to the customer. He then proceeds on to the next stop on his itinerary.

The Integrated Data Terminal 108 updates the system in real time which deliveries have been made, in block 560, and these delivery requests are then removed from the unfilled booking list. The booking list for each of the participating sales outlets 122 is continually updated as bookings are received and deliveries are registered.

Confirm that the Customer has a Deposit on File/Container to Give in Exchange.

Since the presumption is that a deposit has been made if a customer returns any container (even a competitor's), it will be necessary for a customer to provide a container in satisfactory condition in exchange for the one that is being given. No deposits will be accepted in route. New customers must come to a retail sales outlet to register/make a deposit. All customers must register via mail or email for home/direct deliveries.

The Operator obtains SIM (subscriber identity module) cards and contracts for each driver. The Integrated Data terminal 108 can also include this SIM card information. Payment may be made electronically at the time the order is placed, including but not limited to Visa, Mastercard, and other credit and debit card brands, and other forms of cashless payment, for example direct bank account debits, Bitcoin, M-PESA. Other payment mechanisms can also be used.

### GPS Mapping Solutions—Example Process Flow and Components

The Integrated Data Terminals 108 issued to delivery drivers can also contain a GPS/GSM card that provides GPS (Global Positioning System) position data along with GSM (Global System for Mobile communications) cellular communications and that thereby allows mapping of container issue points. On the first visit to a new customer account, the Integrated Data Terminal 108 will record its location (e.g., latitude and longitude coordinates) and associate those coordinates to the customer account. Knowing the customer's location allows the container tracking system to provide mapping and generate routes for delivery drivers for subsequent visits.

Driver movements may be tracked using the GPS/GSM card.

Other communication systems can also be used, and different geographic positioning systems can also be used.

It is noted that the functional blocks described herein for the container tracking system can be implemented using hardware, software, or a combination of hardware and software, as desired. In addition, one or more processors or processing circuitry running software and/or firmware can also be used, as desired, to implement the disclosed embodiments. It is further understood that one or more of the operations, tasks, functions, or methodologies described herein may be implemented, for example, as software or firmware and/or other program instructions that are embodied in one or more non-transitory tangible computer readable mediums (e.g., memory) and that are executed by one or more controllers, microcontrollers, microprocessors, hardware accelerators, and/or other processors or processing circuitry to perform the operations and functions described herein.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method to track containers within a supply chain from filling plants to customers, comprising:
providing integrated data terminals (IDTs) and handheld readers (HRs) to supply chain locations including one or more filling plants (FPs), one or more regional cages (RCs), one or more point of sale (POS) locations, and one or more delivery service (DS) provider locations;
at each supply chain location:
reading data from RFID (radio frequency identification) tags affixed to incoming and outgoing containers using one or more handheld readers;
wirelessly transferring the data from the one or more handheld readers to an integrated data terminal;
wirelessly communicating the data from the integrated data terminal to one or more server systems; and
using the data to update container data stored within a database associated with the one or more server systems.

2. The method of claim 1, wherein the containers, when filled at one or more filling plants, hold at least one of chemicals, gases, LPG (liquefied petroleum gas), beverages, or liquids.

3. The method of claim 1, wherein each filling plant, each regional cage, and each delivery service provider location is provided a first handheld reader configured to read incoming containers and a second handheld reader configured to read outgoing containers.

4. The method of claim 1, wherein each point of sale location is provided a handheld reader configured to read both incoming containers and outgoing containers.

5. The method of claim 1, further comprising, at each supply chain location, reading identification numbers from identification (ID) cards associated with the incoming and outgoing containers and communicating the identification numbers to the one or more server systems.

6. The method of claim 5, wherein the ID cards comprise at least one of ID cards associated with delivery drivers or ID cards associated with customers.

7. The method of claim 1, further comprising, at each filling plant, providing a list of containers due for maintenance and alerting an operator if data read from a container indicates that the container is on the list.

8. The method of claim 1, further comprising, at each filling plant and each regional cage, storing the data within the one or more handheld readers and subsequently downloading of the data to the integrated data terminal.

9. The method of claim 1, further comprising, at each point of sale location, communicating the data from the one or more handheld readers to the integrated data terminal in real time.

10. The method of claim 1, further comprising tracking containers as they move through the supply chain locations and identifying missing containers using the container data stored within the database.

11. A system to track containers within a supply chain from filling plants to customers, comprising:
a plurality of integrated data terminals (IDTs), at least one integrated data terminal being located at a plurality of supply chain locations including one or more filling plants (FPs), one or more regional cages (RCs), one or more point of sale (POS) locations, and one or more delivery service (DS) provider locations;
a plurality of handheld readers (HRs) distributed among the plurality of supply chain locations;
a database configured to store container data; and
one or more server systems coupled to the database;
wherein each handheld reader is configured to read data from RFID (radio frequency identification) tags affixed to containers and to wirelessly transfer the data to an integrated data terminal;
wherein each integrated data terminal is configured to wirelessly communicate the data from a handheld reader to one or more server systems; and
wherein the one or more server systems are configured to use the data to update container data within the database.

12. The system of claim 11, wherein the containers are configured to hold at least one of chemicals, gases, LPG (liquefied petroleum gas), beverages, or liquids.

13. The system of claim 11, wherein the plurality of handheld readers comprise a pair of handheld readers for each filling plant, each regional cage, and each delivery service provider location, each pair of handheld readers including a first handheld reader configured to read incoming containers and a second handheld reader configured to read outgoing containers.

14. The system of claim 11, wherein the plurality of handheld readers comprises a single handheld reader for each point of sale location, each single handheld reader being configured to read both incoming containers and outgoing containers.

15. The system of claim 11, wherein an integrated data terminal or a handheld reader at each supply chain location is configured to read identification numbers from identification (ID) cards associated with the incoming and outgoing containers.

16. The system of claim 15, wherein the ID cards comprise at least one of ID cards associated with delivery drivers or ID cards associated with customers.

17. The system of claim 11, wherein at least one handheld reader at each filling plant is configured to store a list of containers due for maintenance and to alert an operator if data read from a container indicates that the container is on the list.

18. The system of claim 11, wherein handheld readers at the filling plants and regional cages are configured to store the data read from containers for subsequent download to the integrated data terminals.

19. The system of claim 11, wherein handheld readers at each point of sale location are configured to communicate the data in real time read from containers to the integrated data terminals.

20. The system of claim 11, wherein the one or more server systems are configured, using the container data stored within the database, to allow containers to be tracked as they move through the supply chain locations and to allow missing containers to be identified.
